(19) United States
(12) Patent Application Publication
(10) Pub. No.: US 2005/0159976 A1
(43) Pub. Date: Jul. 21, 2005

(54) Method and system for an efficient fundraising campaign over a wide area network

(75) Inventors: Julie A. Schwartz, San Diego, CA (US); James H. Schwartz, San Diego, CA (US); Jeane S. Chen, San Diego, CA (US); Harry E. Gruber, Rancho Santa Fe, CA (US); Ephraim Feig, San Diego, CA (US)

Correspondence Address: FOLEY & LARDNER, P.O. BOX 80278, SAN DIEGO, CA, 92138-0278, US

(73) Assignee: Kintera, Inc.

(21) Appl. No.: 11/064,430

(22) Filed: Feb. 22, 2005

Related U.S. Application Data
(63) Continuation of application No. 09/764,787, filed on Jan. 17, 2001.

(51) Int. Cl. G06F 17/60

(52) U.S. Cl. 705/1; 705/26

(57) ABSTRACT

A system and method for efficiently conducting a fundraising campaign over a wide-area network is provided. In accordance with the invention a method for conducting an efficient fundraising campaign by an organization over a wide-area network includes hosting a website, registering on the website, making a charitable donation on the website, contacting third parties via email messages soliciting charitable donations, and providing one or more reports, on the website, including information on the status of the fundraising campaign. The method further includes contacting third parties, via email messages, to provide information about one or more teams participating in a competition associated with the fundraising campaign. The method further includes providing information, in the reports, about the third parties that have been contacted via email messages. The method further includes providing, in the reports, a real time status of the fundraising campaign, and wherein the real time status provide a convenient means for monitoring the progress of the campaign

### RELATED APPLICATIONS

This application is a Continuation of U.S. patent application Ser. No. 09/764,787, filed Jan. 17, 2001, which is related to a prior application titled “SYSTEMS AND METHOD FOR INTERACTIVE FUNDRAISING OVER A WIDE AREA NETWORK”, filed Dec. 12, 2000, Attorney Docket No. 0001.US00, each of which is incorporated herein by reference in its entirety.

### BACKGROUND

1. Field of Invention

The present invention relates generally to on-line fundraising. More specifically, the present invention relates to a method and system for conducting an efficient fundraising campaign over a wide area network, such as the Internet. The present invention increases the efficiency of a fundraising campaign by providing a fast, convenient and reliable means for conducting the campaign.

2. Description of Prior Art

Charitable and other non-profit organizations often raise money through solicitations. These organizations establish contact with potential donors that may lead the potential donors to make a charitable contribution to the organizations. Common fundraising schemes include media events, mail campaigns, and telephone calls.

Unfortunately, these fundraising schemes are inefficient and suffer from various disadvantages. Briefly stated, traditional fundraising schemes typically do not provide a convenient and efficient means for the donors to communicate among themselves and form teams or groups to compete in a fundraising campaign. Moreover, they fail to provide a real time campaign progress report or real time donor recognition, or donor recognition tied to the solicitor of the gift. Since traditional schemes typically rely on traditional marketing techniques, such as traditional donation solicitations and manual collection of donations, they are time intensive and quite inefficient.

Traditional media fundraising events, including live events, on television and radio are often expensive to stage. Often, only a small fraction of the money received through donations ultimately go to the intended charity as so much money is consumed in the process of simply staging the event. Furthermore, other means are often required to supplement the events. These include appeals via mail and the use of pre-recorded material on radio and television to educate potential donors about the charity and the fundraising event.

Currently, traditional fundraising schemes do not typically provide an efficient means to reach out to an increased number of potential donors and volunteers in order to increase donations. While traditional schemes sometimes utilize volunteers and teams to seek donations, they do not provide a fast and efficient means to recruit the volunteers and form teams. Rather, they rely on mails, phone calls, personal contacts and other time intensive methods to recruit the volunteers. Moreover, traditional schemes do not provide an efficient means for the volunteers and team members to communicate with each other.

Furthermore, traditional schemes do not provide a real time tracking of the fundraising campaign. For example, traditional schemes do not provide a real time progress report of the campaign. Thus, the donors, team members and others associated with the campaign often cannot monitor and track progress of the campaign in real time.

Furthermore, existing fundraising schemes do not provide an efficient and convenient means to motivate donors to make an extra effort for the benefit of the campaign. For example, existing fundraising schemes do not provide an efficient and convenient means for individual donors or teams to compete in the fundraising drive. While some traditional schemes allow the donors to form teams and compete in a fundraising campaign, the donors must rely on time intensive, traditional marketing techniques to recruit team members and monitor performance of the team. Thus, by not providing an efficient and convenient means for the donors and teams to compete in the fundraising campaign and monitor performance, the organization fails to adequately motivate the donors and teams to make an extra effort for the fundraising campaign.

A further problem associated with existing fundraising schemes is the lack of an efficient and convenient means to publicly acknowledge and honor the donors for a short-term or a long-term period. The donors are often motivated to contribute when they are publicly acknowledged and honored for their contribution. While some existing schemes honor the donors during media events or through mails, they are typically inefficient, expensive or time intensive and are often not linked to the person doing the solicitation, i.e., the solicitor.

The disadvantages associated, more specifically, with mail campaigns and telephone calls are also well known. Mail campaigns are slow and time intensive. They often fail to establish the personal contact necessary to motivate a potential donor to make a pledge. Mail campaigns typically cannot efficiently and rapidly honor donors for their contribution. Telephone calls often fail to establish the personal contact necessary to induce a donor to make a contribution. Often, telephone calls annoy recipients and are not very successful as a fundraising scheme or cause the prospect to make a low level gift to get off the phone. These mechanisms do not automatically build an electronic database for future use and do not efficiently track and record information about donors including amount of donation, name of the solicitor, and other demographic and financial information that may be useful in future fundraising. Rather, any data collected from the donor are typically stored in a database by the charitable or nonprofit organizations using staff or volunteers.

In recent years, financial transactions over the Internet or the World Wide Web have become common. The use of credit cards and other financial instruments on the Internet has become sufficiently secure so that there is less reluctance to engage in such transactions by consumers. While some charitable and nonprofit organizations maintain websites on the Internet that are designed to receive donations, they do not provide a comprehensive solution to the above-mentioned disadvantages associated with current fundraising schemes. Consequently, charitable donations online have remained extremely small and comprise only a small fraction of the total amount of charitable donations.

Accordingly, there is a need for a method and system that increases the efficiency of a fundraising campaign over a wide area network, such as the Internet. There is a need for a method and system that replaces traditional marketing techniques such as traditional donation solicitation, manual collection of donation and other time intensive schemes with an efficient and convenient web-based scheme that utilizes the power of the Internet for marketing, solicitations, transactions, data storage and retrieval associated with a fundraising campaign. More specifically, there is a need for an improved on-line interactive fundraising scheme that allows organizations to efficiently, conveniently and cost-effectively reach out to an increased number of potential donors thereby allowing broad participation in the campaign. There is a need for a system and method that allow the donors to conveniently and efficiently form teams, participate in competitions, and communicate with team members. There is a need for a system and method that allow the donors and team members to efficiently and quickly track the progress of the fundraising campaign in real time. There is a further need for an efficient system and method that motivate the donors to compete in the fundraising campaign, thereby creating a competitive environment that ultimately results in increased charitable donations. There is a need to personally recognize donors by the solicitor and reassure the donors that they are donating online to a legitimate charity, rather than a fraudulent site. There is a need to create and store data, especially generated by donors and solicitors, for future fundraising campaigns.

### SUMMARY OF THE INVENTION

It is an object of the present invention to provide a system and method for efficiently conducting a fundraising campaign over a wide-area network. In accordance with the invention a method for conducting an efficient fundraising campaign by an organization over a wide-area network includes the steps of hosting a website including a plurality of linked web pages, the website soliciting potential donors to make a charitable contribution to the fundraising campaign, registering, by the donors, on the website, making a charitable donation on the website, contacting third parties via email messages soliciting charitable donations, and providing one or more reports, on the website, including information on the status of the fundraising campaign. The method further comprises the step of contacting third parties, via email messages, to provide information about one or more teams participating in a competition associated with the fundraising campaign. The method further comprises the step of providing information, in the reports, about the third parties that have been contacted via email messages. The method further comprises the step of providing, in the reports, a real time status of the fundraising campaign, and wherein the real time status provide a convenient means for monitoring the progress of the campaign. The method further comprises the step of joining a team, on the website, to participate in the fundraising campaign. The method further comprises the step of forming a new team, on the website, to participate in the fundraising campaign. The method further comprises the step of recruiting new team members by email messages.

Also, in accordance with the present invention, a system for conducting an efficient fundraising campaign by an organization over a wide-area network includes a website having a plurality of linked web pages, the website soliciting potential donors to make a charitable contribution to the fundraising campaign, means for registering on the website, means for making a charitable donation on the website, means for contacting third parties via email messages soliciting charitable donations, and one or more reports on the website including information on the status of the fundraising campaign. The email messages to the third parties include information about one or more teams participating in a competition associated with the fundraising campaign. The reports include information about the third parties that have been contacted via the email messages.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like elements, in which:

FIG. 1 is a block diagram of one embodiment of the present invention in association with a wide area network;

FIG. 2 is a flow diagram of operational steps for conducting a fundraising campaign in accordance with one embodiment of the present invention;

FIG. 3 illustrates an exemplary registration web page in accordance with one embodiment of the present invention;

FIG. 4 illustrates an exemplary donation web page in accordance with one embodiment of the present invention;

FIG. 5 illustrates a flow diagram sequencing steps of forming a team in accordance with one embodiment of the present invention;

FIG. 6 illustrates an exemplary team web page;

FIGS. 8, 9 and 10 illustrate exemplary web pages that allow donors, solicitors or registrants to recruit new team members;

FIG. 11 illustrates an exemplary web page that allows a third party to make a donation on behalf of a donor or solicitor; and

FIGS. 12 and 13 illustrate exemplary reports provided by the present invention.

### DETAILED DESCRIPTION OF THE INVENTION

Turning first to the nomenclature of the specification, the detailed description which follows is represented largely in terms of system block diagrams, processes and symbolic representations by conventional computer components, including a processor associated with a general-purpose computer system, memory storage devices for the processor, and connected display devices. These operations include the manipulation of data bits by the processor and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purpose of this discussion, a solicitor refers to a person or an organization soliciting a potential donor or an organization for a charitable donation. The solicitor may be a volunteer, an agent or an employee of a charitable, nonprofit or other organization. The solicitor may be a commercial fundraiser or an agent or employee thereof engaged for the purpose of assisting a charitable or other organization in its fundraising campaign. A donor refers to a person or an organization that makes a charitable donation. Also for the purpose of this discussion, a process or method is generally conceived to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, terms, numbers, records, files or the like. It should be kept in mind, however, that these and some other terms should be associated with appropriate physical quantities for computer operations, and that these terms are merely conventional labels applied to physical quantities that exist within and during operation of the computer.

In addition, it should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

The present invention provides a solution to the above-mentioned problems associated with existing fundraising schemes. Briefly stated, the present invention is directed to a method and system for an efficient fundraising campaign by an organization over a wide area network, such as the Internet. The present invention enhances traditional marketing techniques, such as traditional donation solicitation, manual collection of donation and other time intensive schemes with an efficient and fast web-based scheme that utilizes the power of the Internet to create broad participation in the campaign. The present invention allows an organization to efficiently and conveniently reach out to an increased number of potential donors, thereby increasing the amount of charitable donations raised and decreasing administrative costs associated therewith. The present invention provides a system and method to import credit card data, checks or wire transferred data from individuals, donors, solicitors, charitable and other organizations.

The present invention allows donors to conveniently recruit additional donors via email messages to join a team and participate and compete in the fundraising campaign. The invention further allows the team members to solicit donations from third parties, such as friends, co-workers and family via email messages or in combination with other physical means of solicitation such as paper mail. This is an effective fundraising tool as the email messages are typically sent by friends, co-workers and family, rather than by unknown third parties. A potential donor is more likely to contribute to a charitable cause when solicited by a friend, co-worker or a family member, rather than by an unknown third party. The present invention motivates donors to compete in the fundraising campaign, thereby creating a competitive environment that ultimately results in increased charitable donations. Furthermore, the present invention provides reports that allows real time tracking of the campaign.

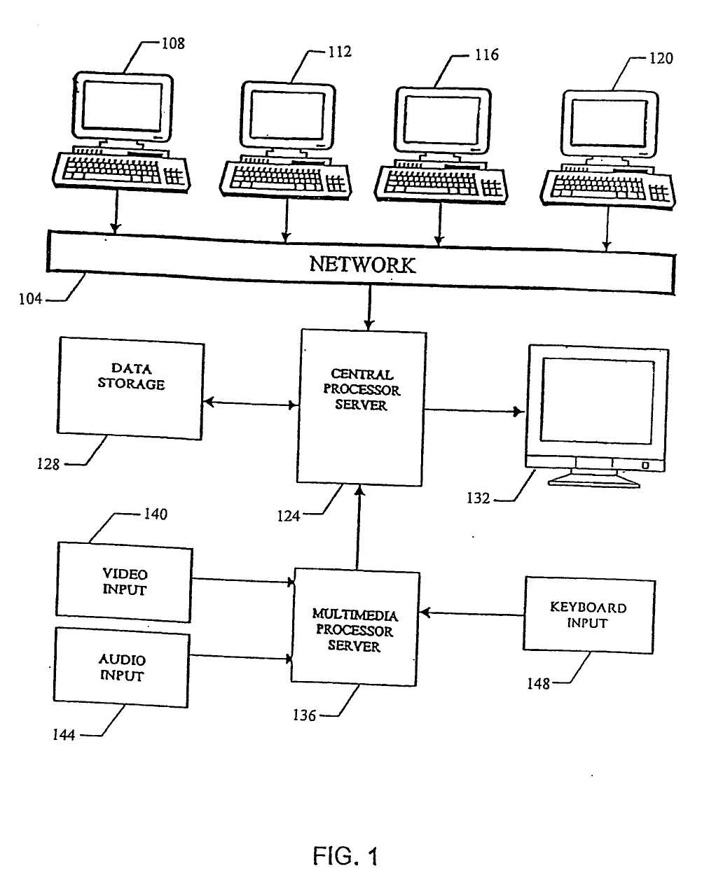

Referring now in more detail to the drawings, FIG. 1 is a block diagram of the present invention in association with a wide-area network. In FIG. 1, a wide-area network (e.g., the Internet) 104 is shown in conjunction with a number of representative user stations 108, 112, 116, and 120. It is well known in the art how to structure such wide-area network connections to provide two-way communication between various stations and locations connected to the network. In FIG. 1, a representative central processor server 124 is shown connected to the network 104 for two-way interactive communication between the central processor server 124 and the plurality of user stations. Also, as is well known in the art, many levels of communication can occur across network 104 as among individual stations and as between central processor servers and individual stations.

In one embodiment of the present invention, central processor server 124 would be a computer system established by the fundraising organization or its agent for the purpose of providing information to potential donors and for the purpose of soliciting contributions and also receiving pledges and donations. It is to be understood, however, that the central processor server 124 may also be a computer system operated by an organization specifically set up to carry out fundraising events and programs for a variety of charities and nonprofit organizations. The operation of the system and the methods involved are the same regardless of the nature of the organization that establishes and carries out the on-line functionality of the system.

The central process server 124 is linked to a data storage device 128 as well as to an appropriate display device 132. These mechanisms simply provide the means for storing information for presentation to the viewers, as well as the means for receiving information from viewers, either for immediate display or recording for later access.

Also associated with the central processor server 124 is a multimedia processor server 136. In some instances, the multimedia server 136 may simply comprise specific components contained within the central processor server 124 appropriate for receiving, digitizing, and transmitting multimedia data associated with an interactive event. In other instances, it would be preferable to have a separate hardware device carrying out the functions of the multimedia processor server and providing them to central processor server in the form of digital data configured and ready for broadcast over the network. In any event, the multimedia processor server 136 is structured to receive inputs from a video input 140, an audio input 144, and an input device 148. The input device can be a keyboard, a touch pad or any other input device

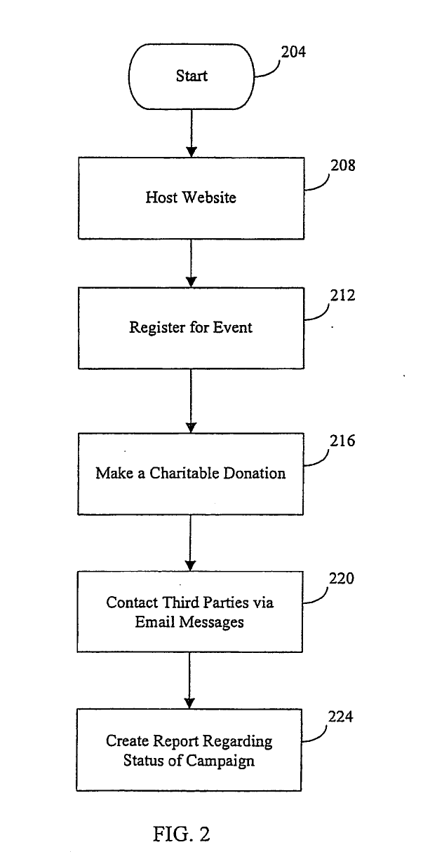

Reference is now made to FIG. 2, wherein a flow diagram illustrates the sequence of operational steps for conducting an efficient, web-based fundraising campaign in accordance with one embodiment of the present invention. The flow begins at step 204 and proceeds to step 208 where a website including information about a fundraising campaign is hosted. The website is accessible on the Internet and may be hosted by an organization that is conducting the fundraising campaign or by a third party contracted to assist in the campaign. The organization can be a charitable, a non-profit, a political action committee (PAC), a political organization, or any other organization engaged in a lawful fundraising effort.

The method then proceeds to step 212 where the potential donor registers to participate in the fundraising campaign and any event associated therewith. The fundraising campaign can include various events, such as an athletic event, a fundraising gala or a dinner, a homecoming event, a bowling event, a networking event, an awards meeting, an annual meeting, a conference, a lecture or any other event. The athletic event can be tennis, boating, golf, surfing or any other sporting event. Thus, when a potential donor registers, the potential donor also agrees to participate in the event. However, the fundraising campaign can also be run as a competition to raise money without being associated with a physical event. The fundraising campaign can be run with only a linkage to an awards ceremony for the top fundraisers, or all or some of the fundraisers. In one embodiment the fundraising event can be associated with the sale of merchandise such as magazines, candy and gift wrap, wherein a percentage of the revenue belongs to the nonprofit organization. The invention can remove the need for the solicitor to go door to door to strangers and thereby reduce the emotional issues of cold calling and the risks of going to strangers homes.

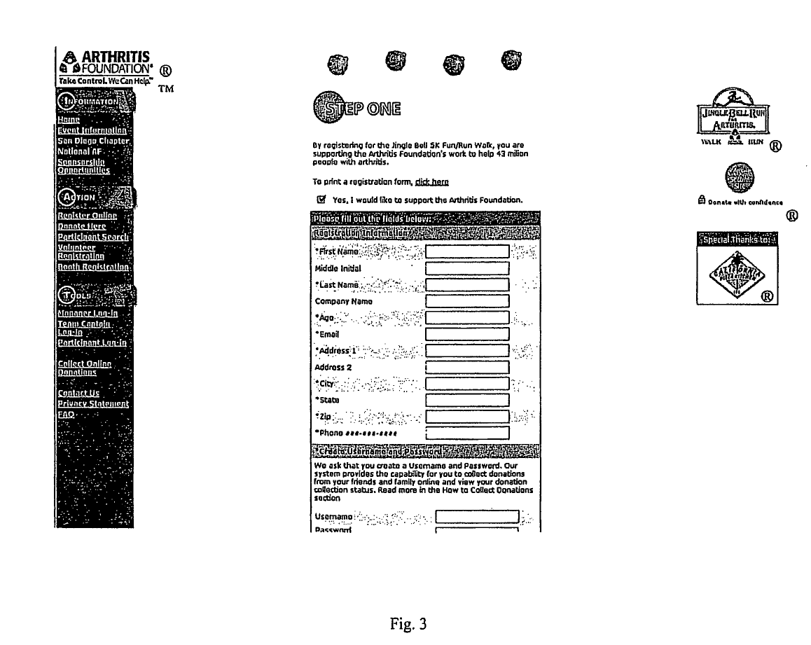

In one embodiment, the registration is carried out on one or more registration web pages as shown in FIG. 3. The web page, or pages linked to the web page, is configured to receive information, such as name, age, address, and telephone number of the registrant. The registration web pages also provide information regarding registration fees, donation levels, gifts and prizes, and allows the registrant to create a user name and a password. In one embodiment, the page contains information about prior donors such as name, amount of donation, etc. In one embodiment, the page contains motivational information about the organization, the charitable cause, and/or personalized requests from the solicitor. The solicitor may make a request by an email in which case, the email may include a link to the solicitor's personalized web page as will be explained later.

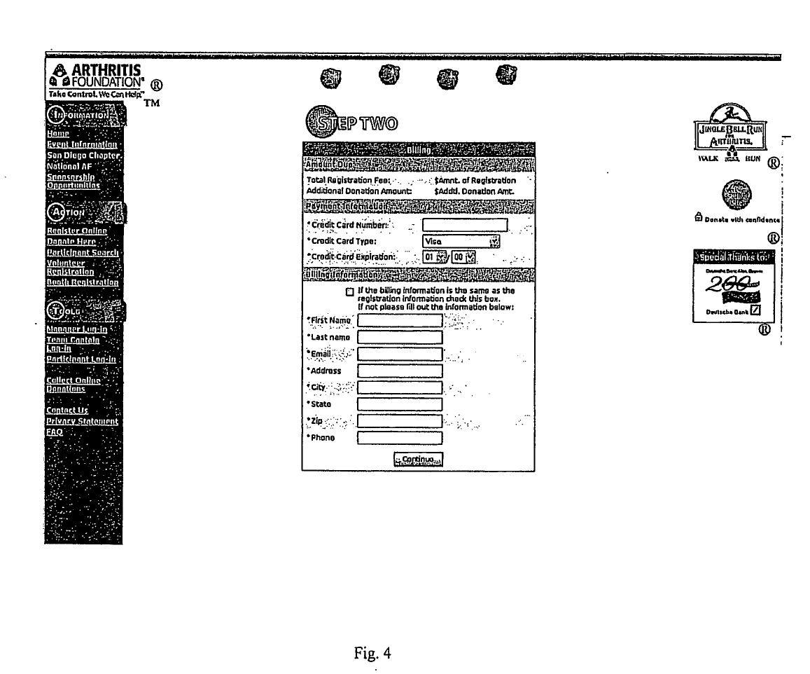

The method then proceeds to step 216, where the registrant makes a donation on the website. In one embodiment, the registrant can make a charitable donation on a payment web page as shown in FIG. 4. The web page is configured to receive billing information such as credit card number, name, address, etc.

The method then proceeds to step 220, where the registrant contacts third parties via email messages seeking charitable donations for the campaign. As noted before, the invention provides an efficient means for a registrant to contact third parties, such as friends, co-workers and family and seek additional donations. The registrant can ask third parties to simply make a donation to the campaign and/or participate in an event associated with the campaign. Thus the invention allows the campaign to efficiently reach out to an increased number of potential donors, while decreasing the cost associated with the administration of the campaign.

Next, the method proceeds to step 224, where a report regarding the status of the campaign is provided to the registrant in a web page. The report provides a convenient means for tracking the campaign in real time. In one embodiment, the report includes names, addresses and other information about the third parties that have been contacted by email messages. The report can also provide information regarding any responses received from the third parties. For example, the report can indicate if the third parties have opened the email messages, clicked on a html or other uniform resource locator (URL) link in the email, registered for an event, purchased something and if they have made a charitable donation.

In one embodiment, the invention, through the report, allows the registrant to track the donations collected using the username and the password. The registrant can also set a fundraising goal and is encouraged to collect donations from friends, co-workers and family to reach the fundraising goal. The fundraising goal and the amount raised can by displayed on a personalized web page of the solicitor.

Furthermore, the report provides tax related information, such as an automatic tax receipt, the amount of donation, and the amount that is tax deductible.

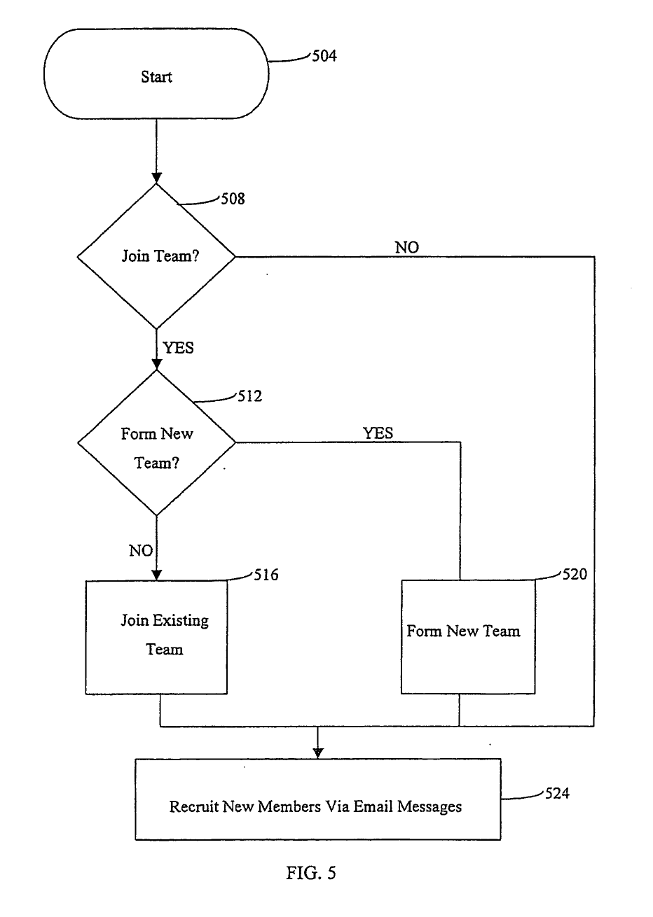

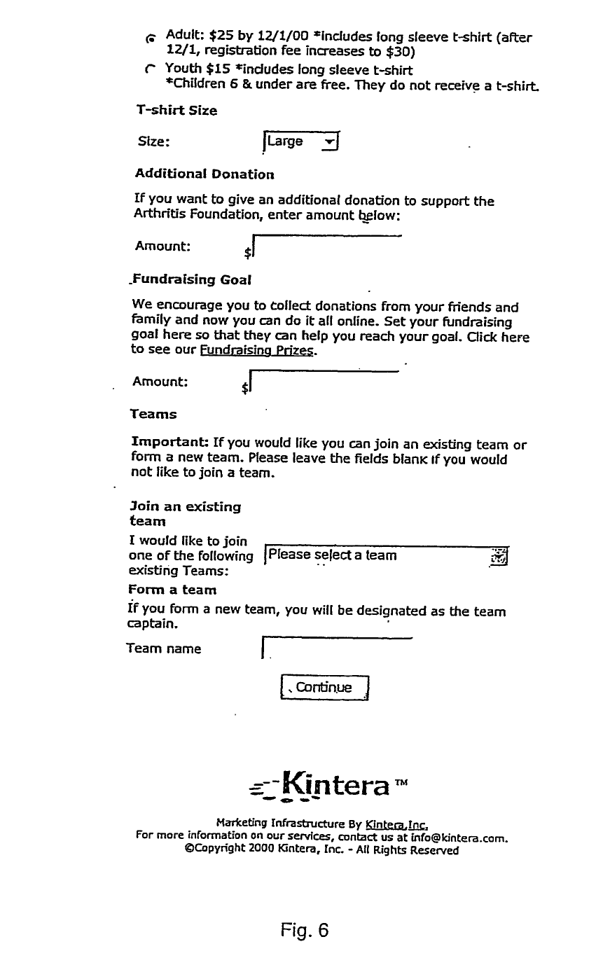

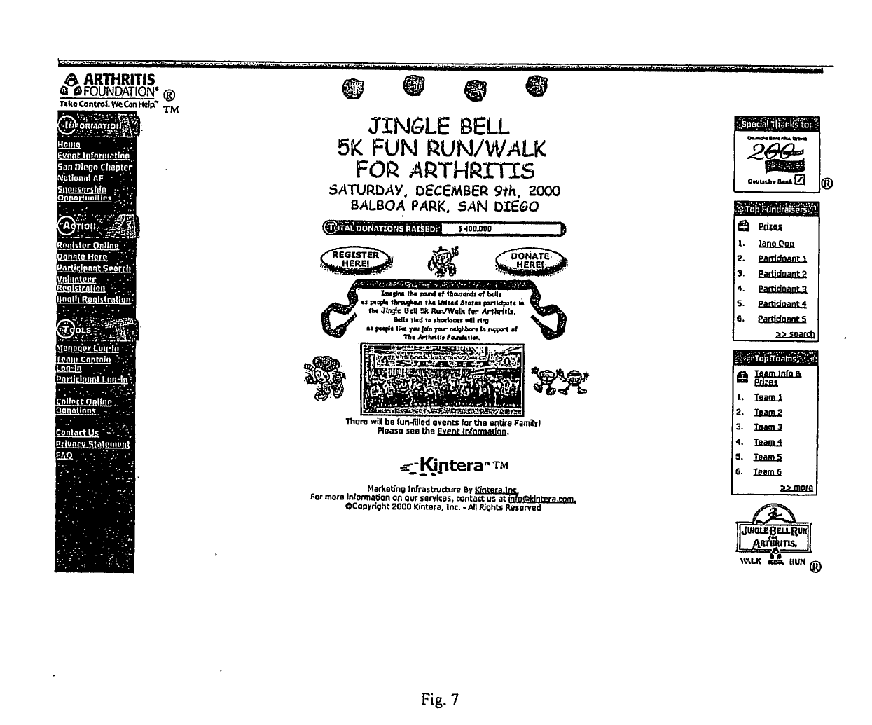

As noted before, the present invention allows the registrants and/or donors to participate in a competitive event associated with the fundraising campaign. The invention allows the registrants and/or donors to conveniently form teams, participate in competitions and communicate with team members. FIG. 5 illustrates a flow diagram sequencing the steps of forming a team in accordance with one embodiment of the invention. Referring now to FIG. 5, the method starts at step 504 and proceeds to decision block 408 where the donor/registrant makes a decision whether to join a team. If the donor/registrant decides to join a team, the flow proceeds to decision block 512 where the donor/registrant decides whether to form a new team or not. If the donor/registrant decides not to form a new team, the flow proceeds to step 516 where the donor/registrant joins an existing team. In one embodiment, a search engine is used to locate a team from a list of existing teams. If the donor/registrant decides to form a new team, the flow moves to step 520 where the donor/registrant creates a new team and the donor/registrant will be designated as the team captain of the new team. In step 524, the donor/registrant can recruit new members, via email messages, to join the team. The donor/registrant can also solicit donations via email messages from third parties and new members and ask them to participate in the fundraising drive. The decision whether to join an existing team or to form a new team can be made on a team web page shown in FIG. 6. The team web page provides a convenient means for a donor/registrant to join an existing team or to form a new team.

In one embodiment, the invention encourages the teams to compete in the fundraising drive by providing a reward to the winning team. The reward can be a prize or some other form of recognition. This increases competitive environment by encouraging teams who are behind in total amount raised to more aggressively solicit friends and family members to participate and donate.

Each team participates in the fundraising campaign by allowing the members to seek donations from friends, family and others. The team members utilize e-mails (or other means such as mails, telephone calls, etc.) to contact friends, co-workers and family and solicit donations. When a team member receives donations, both the individual member and the team are credited with the amount raised. In some instances, organizations are structured hierarchically, such as local, regional and national levels or chapters. In such cases, when multiple chapters of the organization are involved in the campaign, the local, regional or national sites can be viewed as teams.

The teams are then ranked and displayed based on the total amount of donations they collect. In one embodiment, the teams compete for a reward, prize or recognition. The invention utilizes virtual plaques to recognize and honor individual donors and teams. The virtual plaques also display, in real time, team totals and individual member contributions, thereby fostering a competitive environment. The virtual plaques can show individual contributors and their gift levels or amounts, especially on a solicitors page or winners (teams or individual fundraisers) of a local, regional and national competition. FIG. 7 illustrates a web page that includes virtual plaques honoring top fundraisers and top teams. The virtual plaques can also be incorporated on a solicitor's web page or any other web page for increased publicity. The invention thus provides a convenient way to honor donors by publicly acknowledging them through virtual plaques. The virtual plaques are described in greater detail in the above-mentioned co-pending application, which is incorporated herein by reference.

The ability to efficiently and conveniently form teams, recruit new team members and solicit donations from friends, co-workers and family is an important feature of the invention. Rather than relying only on donations from the donor, the invention encourages the donor to take a more active role in the fundraising drive by recruiting additional donors. This allows the organization to reach out to additional potential donors through an initial donor/registrant. This results in a large number of additional donors being recruited as each donor/registrant can use the convenient means provided by the invention to recruit one or many additional donors.

The invention allows the newly-recruited team members to conveniently send emails to friends, co-workers and family soliciting donations. The email message may include a description of the fundraising campaign and the charitable cause associated therewith. The invention also provides means to import email data manually or by file transfers. The means allowing newly-recruited team members to send email messages to friends, co-workers and family to solicit donations is an important feature of the invention. The newly-recruited team members act as active volunteers for the fundraising campaign, increasing the total number of persons working for the success of the fundraising campaign. Also, as noted before, potential donors are more likely to contribute to a charitable cause when contacted by friends, co-workers and family, rather than by unknown third party. This feature can significantly increase the total amount of donations received in a fundraising campaign.

In one embodiment, a link (e.g., a uniform resource locator (URL) link) to a personalized web page is automatically embedded in the email messages. According to the present invention, the information collected from a registrant is used to generate a personalized donation web page and a link to the personalized donation web page. When the registrant (i.e., solicitor) sends an email to friends, co-worker or family seeking donations, the link is automatically embedded in the email. The recipient of the email can click onto the link and be directed to the personalized donation web page. In one embodiment, the personalized donation web page is co-branded with the web page of the organization conducting the fundraising campaign. In other words, the personalized donation web page can be incorporated into the web page of the organization. This assures the recipient that the solicitation is for a legitimate charity since the personalized donation web page is incorporated into a web page belonging to a well-known organization and the donor believes the solicitor has formed a relationship with a legitimate nonprofit organization.

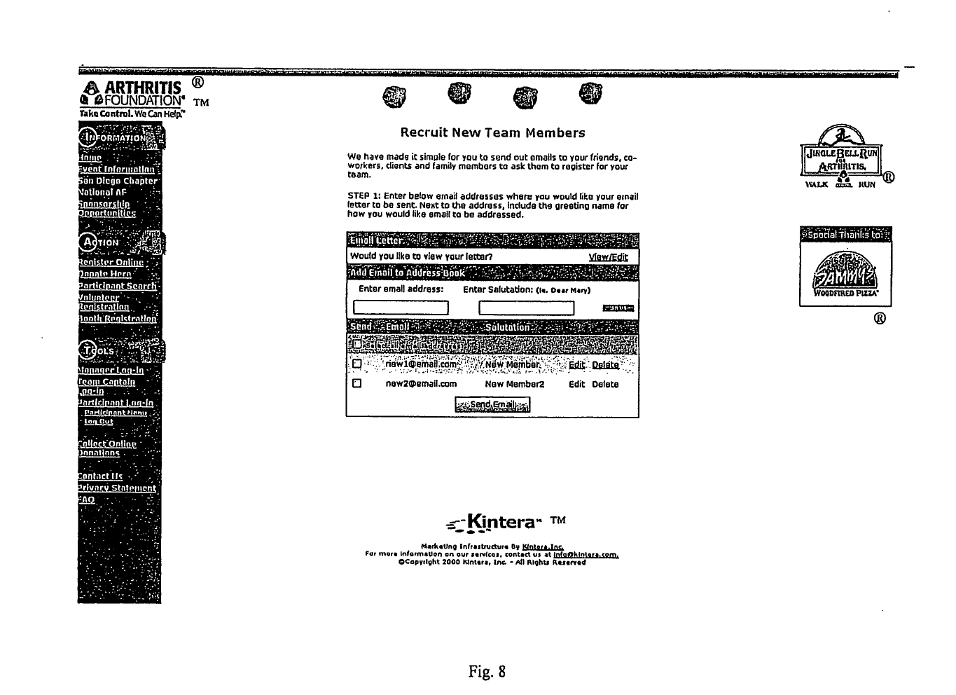

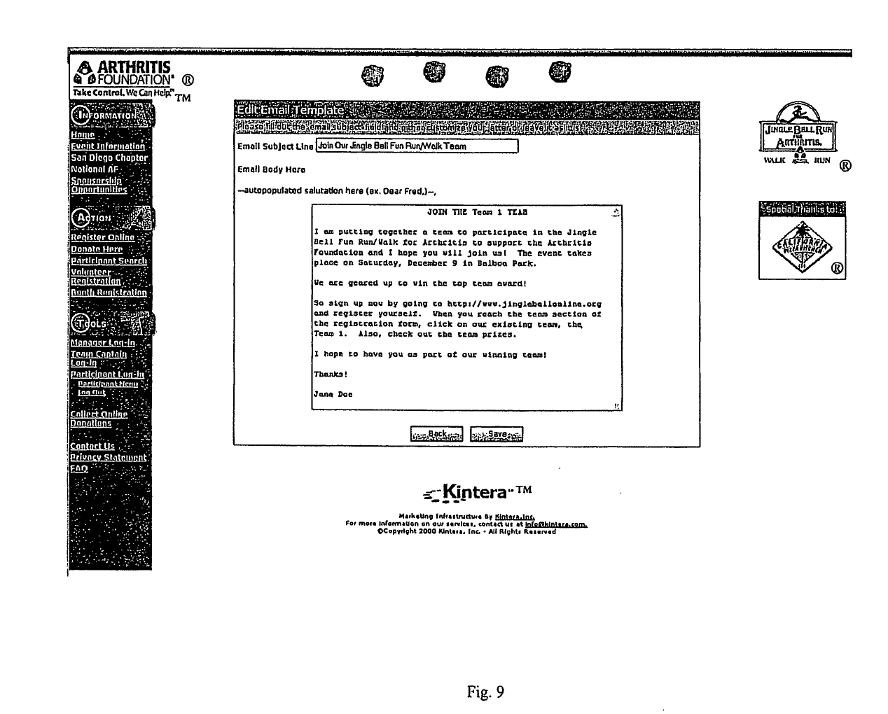

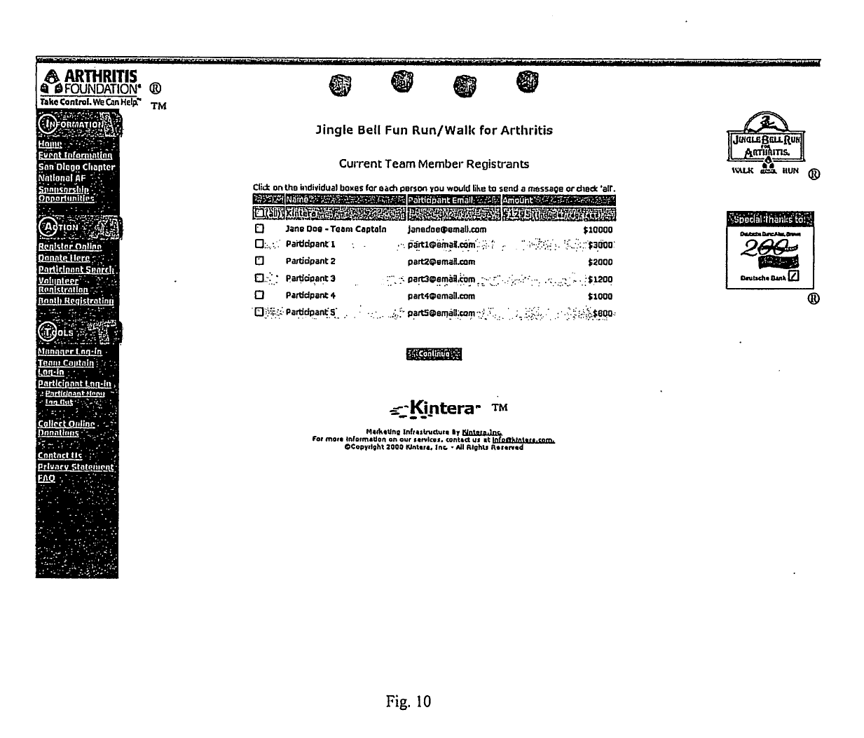

In one embodiment, a person is not required to make a donation in order to participate in the event associated with the fundraising campaign. A person can register to participate in an event and may also send emails to friends, co-workers and family to solicit donations without making a donation. As noted before, the invention allows a donor/registrant to recruit new members via email messages. The email messages may solicit donations for the campaign, ask third parties to join a team, and compete in the fundraising campaign. The invention provides a convenient means for a donor/registrant to send emails to friends, co-workers, clients, family members and ask them to register for the team. FIGS. 8, 9 and 10 illustrate web pages that allow a donor/registrant to recruit new team members.

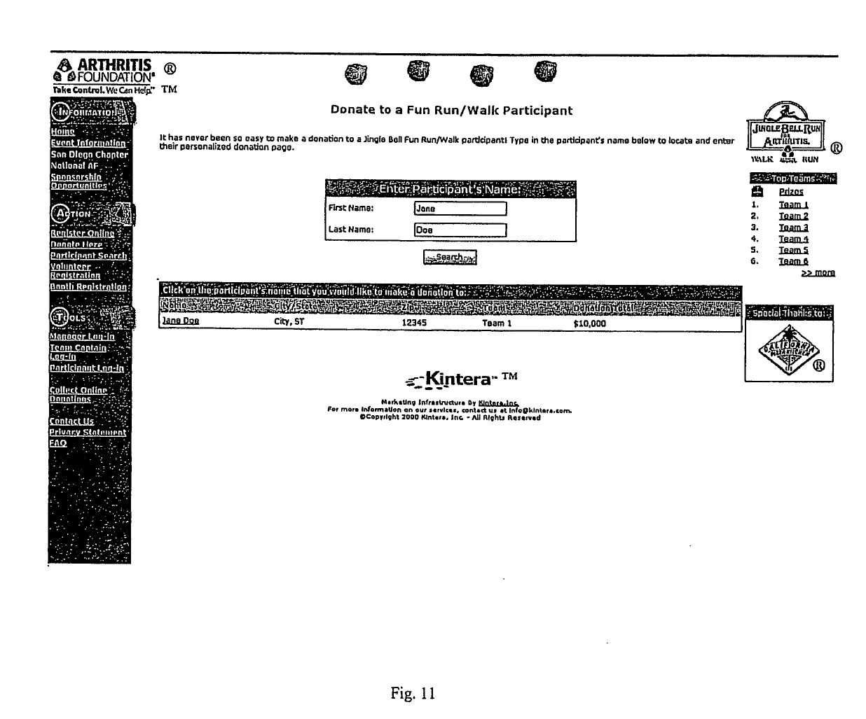

In one embodiment, the invention provides a means for a third party to make a donation on behalf of another donor. For example, consider a scenario wherein a charitable organization is conducting a fundraising drive. In association with the fundraising drive, the organization is promoting a walkathon. A donor can support the fundraising drive by registering (by paying a registration fee) and participating in the walkathon. The invention provides a convenient means for a third party to locate the participant donor's personalized donation page and make a donation on the participant donor's behalf. FIG. 11 illustrates a web page that allows a third party to make a donation on behalf of a participant donor.

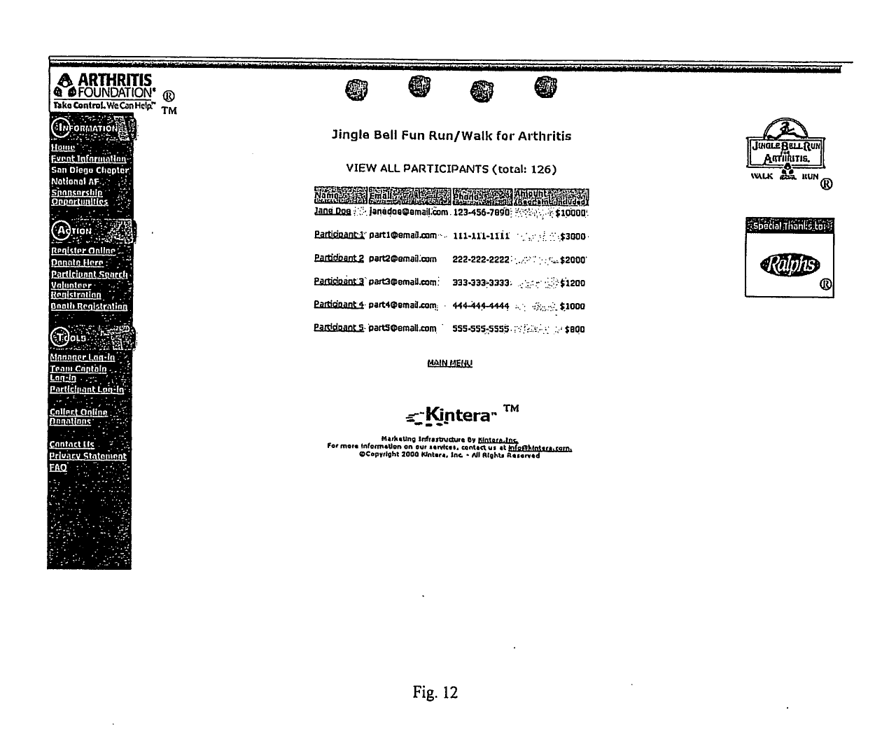

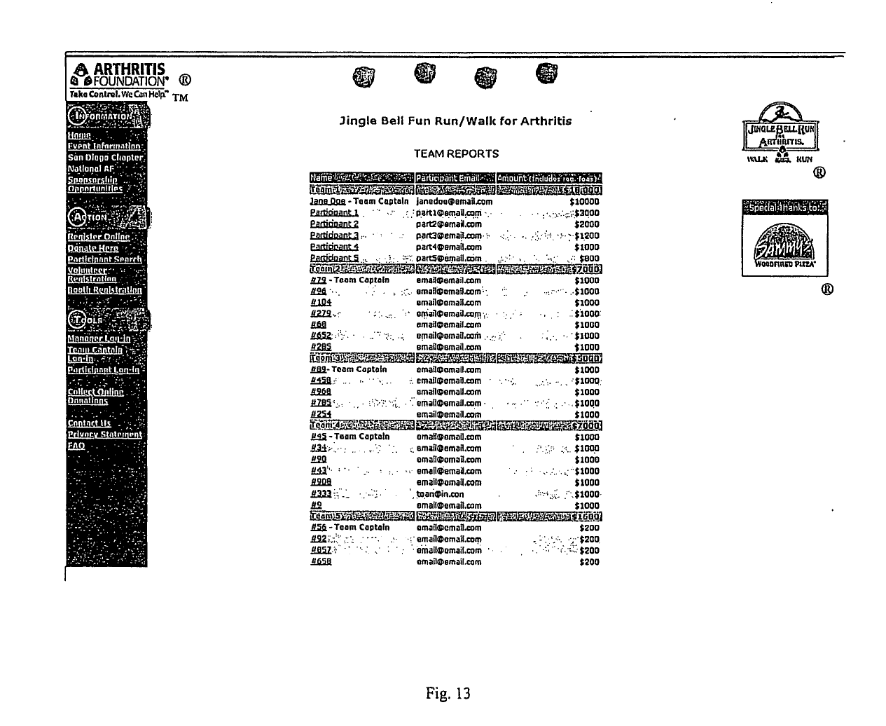

The invention further provides convenient means to track the progress of the fundraising campaign in real time. For example, the invention provides one or more donor reports that list the names of donors, donated amounts, their addresses, etc. The invention also provides a team report that includes similar information about the teams. The reports can also include the names of third parties that have been contacted and those that have responded. Various other reports can be generated to closely track and monitor the state of the fundraising campaign in real time. FIG. 12 illustrates an exemplary donor report and FIG. 13 illustrates an exemplary team report. The report can include the entire email trail (or the email tree). The report can list the name of the initial solicitor and all subsequent recipients of the emails. For example, suppose the initial solicitor sends an email to ten friends. Next, each of the ten friends sends email to ten other friends. The report will then include the names, addresses and other information of all the persons contacted by the email.

The invention can also be considered a system comprising various linked web pages that allow an organization to efficiently conduct a fundraising campaign. In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium. A manufacturer can make the software program available for sale so that individuals and business entities may purchase or otherwise obtain the software program to set up an automated, on-line donation processing system.

Thus, it is apparent that there has been provided, in accordance with the present invention, a system and method for efficiently conducting a fundraising campaign by an organization over a wide-area network. Although the preferred embodiments have been described, it should be understood that various changes, substitutions, and alterations can be made herein without departing from the scope of the present invention. For example, although the present invention has been described and illustrated primarily in relation to Internet applications, it should be understood that the present invention is in no way limited to only the Internet and may be implemented on other networks also. It should be understood that the application of the present invention is not limited only to fundraising campaigns. Rather, the present invention can be implemented to perform all forms of financial and other transactions over a wide area network that will be apparent to those skilled in the art. For example, the current invention can be used as a marketing tool to sell products or services for a for profit organizations. In this embodiment, the solicitor might receive a percentage of revenue received by the people solicited or by the people solicited by the solicitor. Furthermore, it should be noted that the present invention can be implemented using virtually any computer system or other networking system and virtually any available programming language. Thus the implementation of the present invention is not limited to the computer network illustrated in this document. Other examples of changes, substitutions, and alterations are readily ascertainable by one skilled in the art and could be made without departing from the spirit and scope of the present invention as defined by the following claims.

1-54. (canceled)

55. A method for conducting a fundraising campaign by an organization over a wide-area network, comprising the steps of:
hosting a website including a plurality of linked web pages, the website providing information about the fundraising campaign and soliciting potential donors to make a charitable contribution to the fundraising campaign;
registering, by a solicitor, on the website;
contacting, by the solicitor, third parties via email messages soliciting charitable donations;
providing one or more reports, on the website, including information on the status of the fundraising campaign;
providing a link to a personal donation page in the email messages, the personal donation page having the name and personal campaign goal of the solicitor;
receiving a charitable contribution, by a donor, on the personal donation page; and
displaying one or more web pages with a virtual plaque honoring the donor.

56. The method as recited in claim 55, further comprising the step of:
updating the vital plaque on the web pages to recognize new donors.

57. The method as recited in claim 55, further comprising the step of:
forming teams on the website, to participate in the fundraising campaign by soliciting donations by emails, wherein the teams compete with each other to raise money.

58. The method as recited in claim 57, further comprising the step of recruiting new team members by email messages.

59. The method as recited in claim 58, wherein the newly-recruited members can join existing teas.

60. The method as recited in claim 58, wherein the newly-recruited members can form new teams.

61. The method as recited in claim 58, wherein the newly-recruited members can recruit other donors by email messages.

62. The method as recited in claim 55, further comprising the step of contacting third parties, via email messages, to provide information about one or more teams participating in a competition associated with the fundraising campaign.

63. The method as recited in claim 55, further comprising the step of providing information, in the reports, about the third pares that have been contacted via email messages.

64. The method as recited in claim 55, further comprising the step of providing, in the reports, a real time status of the fundraising campaign, and wherein the real time status provides a convenient means for tracking the progress of the campaign.

65. The method as recited in claim 55, further comprising the step of joining a team, on the website, to participate in the fundraising campaign.

66. The method as recited in claim 55, wherein the fundraising campaign includes an athletic event.

67. The method as recited in claim 55, wherein the fundraising campaign includes a gala event.

68. The method as recited in claim 55, wherein the fundraising campaign includes a networking event.

69. The method as recited in claim 55, wherein the fundraising campaign includes a sell-a-thon where magazines or other items are sold for the benefit of the fundraising campaign.

70. The method as recited in claim 55, wherein the fundraising campaign includes a competition without another event.

71. The method as recited in claim 55, fiercer comprising the step of providing a personalized donation page for a solicitor.

72. The method as recited in claim 71, wherein the emails include a link to the personalized donation page.

73. The method as recited in claim 71, wherein the personalized donation page is incorporated into website of the organization or person conducting the fundraising campaign.

74. The method as recited in claim 55, wherein the report includes tax related information.

75. The method as recited in claim 55, wherein the wide-area network is the Internet.

76. The method as recited in claim 55, wherein the organization is a charitable organization.

77. The method as recited in claim 55, wherein the organization is a political action committee.

78. The method as recited in claim 55, wherein the organization is a political organization.

79. The method as recited in claim 55, wherein a person conducts the fundraising campaign.

80. A system for conducting a fundraising campaign by an organization or person over a wide-area network, comprising:
a website including a plurality of linked web pages, the website providing information about the fundraising campaign and soliciting potential donors to make a charitable contribution to the fundraising campaign;
means for registering on the website;
means for contacting third parties via email messages soliciting charitable donations;
one or more reports on the website including information on the status of the fundraising campaign;
a link to a personal donation page in the email messages, the personal donation page having the name and personal campaign goal of a solicitor;
means for receiving a charitable contribution, by a donor, on the personal donation page; and
means for displaying one or more web pages with a virtual plaque honoring the donor.

81. The system as recited in claim 80, further comprising:
means for updating the virtual plaque on the web pages to recognize new donors.

82. The system as recited in claim 80, further comprising:
means for forming teams, on the website, to participate in the fundraising campaign by soliciting donations by emails, wherein the teams compete with each other to raise money.

83. The system as recited in claim 82, fierier comprising means for recruiting new team members by email messages.

84. The system as recited in claim 83, further comprising means, for the newly-recruited team members, to recruit others by email messages.

85. The system as recited in claim 80, wherein the email messages to the third parties include information about one or more teams participating in a competition associated with the fundraising campaign.

86. The system as recited in claim 80, wherein reports include information about the third parties that have been contacted via the email messages.

87. The system as recited in claim 80, wherein the reports include real time status of the fundraising campaign, and wherein the real time status provides a convenient means for tracking the progress of the campaign.

88. The system as recited in claim 80, further comprising means for joining a team, on the website, to participate in the fundraising campaign.

89. The system as recited in claim 80, wherein the fundraising campaign includes an athletic event.

90. The system as recited in claim 80, wherein the fundraising campaign includes a gala event.

91. The system as recited in claim 80, wherein the fundraising campaign includes a networking event.

92. The system as recited in claim 80, wherein the fundraising campaign includes an event where magazines or other items are sold for the benefit of the fundraising campaign.

93. The system as recited in claim 80, wherein the fundraising campaign includes a competition without any other event.

94. The system as recited in claim 80, further comprising a personalized donation page for a solicitor.

95. The system as recited in claim 94, wherein the emails include a link to the personalized donation page.

96. The system as recited in claim 94, wherein the personalized donation page is incorporated into a web page of the organization or person conducting the fundraising campaign.

97. The system as recited in claim 80, wherein the report includes tax related information.

98. The system as recited in claim 80, herein the organization is a charitable organization.

99. The system as recited in claim 80, wherein the organization is a political organization.

100. The system as recited in claim 80, wherein the fundraising campaign in conducted by a person.

101. A computer program product including a program code embodied in a storage medium for carrying out a method for conducting a fundraising campaign by an organization over a wide-area network, the method comprising the steps of:
hosting a website including a plurality of linked web pages, the website providing information about the fundraising campaign and soliciting potential donors to make a charitable contribution to the fundraising campaign;
registering, by a solicitor, on the website;
contacting, by the solicitor, third parties via email messages soliciting charitable donations;
providing one or more reports, on the website, including information on the status of the fundraising campaign;
providing a link to a personal donation page in the email messages, the personal donation page having the name and personal campaign goal of the solicitor;
making a charitable contribution, by a donor, on the personal donation page;
displaying one or more web pages with a vial plaque honoring the donor.

102. A method for conducting a fundraising campaign by an organization over a wide-area network, comprising the steps of:
hosting a website for providing information about the fundraising campaign and soliciting potential donors to make a charitable contribution to the fundraising campaign;
providing a link to a personal donation page in one or more email messages from a solicitor to third parties, the personal donation page having the name and personal campaign goal of the solicitor;
receiving a charitable contribution from a donor on the personal donation page; and
displaying one or more web pages on the website with a virtual plaque honoring the donor.

103. A system for conducting a fundraising campaign by an organization or person over a wide-area network, comprising:
a website for providing information about the fundraising campaign and soliciting potential donors to make a charitable contribution to the fundraising campaign;
a link to a personal donation page in one or more email messages from a solicitor to third parties, the personal donation page having the name and personal campaign goal of a solicitor;
means for receiving a charitable contribution from a donor on the personal donation page; and
means for displaying one or more web pages with a virtual plaque honoring the donor.

104. A computer program product including a program code embodied in a storage medium for carrying out a method for conducting a fundraising campaign by an organization over a wide-area network, the method comprising the steps of:
hosting a website for providing information about the fundraising campaign and soliciting potential donors to make a charitable contribution to the fundraising campaign;
providing a link to a personal donation page in one or more email messages from a solicitor to third parties, the personal donation page having the name and personal campaign goal of the solicitor;
receiving a charitable contribution from a donor on the personal donation page; and
displaying one or more web pages on the website with a virtual plaque honoring the donor.

105. A method for conducting a fundraising campaign by an organization over a wide-area network, comprising the steps of:
hosting a website including a plurality of linked web pages, the website providing information about the fundraising campaign and soliciting potential donors to make a charitable contribution to the fundraising campaign;
contacting, by a solicitor, third parties via email messages soliciting charitable donations;
providing one or more reports, on the website, including information on the status of the fundraising campaign;
providing a link to a personal donation page in the email messages, the personal donation page having the name and personal campaign goal of the solicitor;
receiving a charitable contribution, by a donor, on the personal donation page; and
forming teams on the website, to participate in the fundraising campaign by soliciting donations by emails, wherein the teams compete with each other to raise money.

106. A method for donating to a fundraising campaign of an organization over a wide-area network, comprising the steps of:
receiving, by a donor, an email message from a solicitor, the email message including a link to a personal donation page, the personal donation page having the name and personal campaign goal of the solicitor; and
making a charitable contribution on the personal donation page; and
downloading one or more web pages with a virtual plaque honoring the donor.

107. A method for donating to a fundraising campaign of an organization over a wide-area network, comprising the steps of:
receiving, by a donor, an email message from a solicitor, the email message including a link to a personal donation page, the personal donation page having the name and personal campaign goal of the solicitor; and
making a charitable contribution on the personal donation page; and
receiving an assignment to one of a plurality of teams to participate in the fundraising campaign by soliciting donations by emails, wherein the teams compete with each other to raise money.
